(19) United States
(12) Patent Application Publication
(10) Pub. No.: US 2003/0207161 A1
(43) Pub. Date: Nov. 6, 2003

(54) Hydrogen production and water recovery system for a fuel cell

(76) Inventors: Ali Rusta-Sallehy, Richmond Hill (CA); Nathaniel Ian Joos, Toronto (CA); David Frank, Scarborough (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/135,518

(22) Filed: May 1, 2002

(51) Int. Cl. H01M 8/06; H01M 8/04

(52) U.S. Cl. 429/20; 429/21; 429/26; 429/17

(57) ABSTRACT

A hydrogen production and water recovery system for a fuel cell utilizes hydrogen storage in a metal hydride or the like. An exhaust stream from the fuel cell is passed through the storage media, simultaneously to cool the exhaust stream to promote condensation of water vapor and to heat the media to promote generation of hydrogen. The recovered water can be stored, returned to a coolant loop, and at a later time electrolyzed to generate hydrogen.

### FIELD OF THE INVENTION

This invention relates to fuel cell systems. More particularly, this invention relates to a system which uses metal hydride to store hydrogen and which recovers water from the fuel cell exhaust stream.

### BACKGROUND OF THE INVENTION

Fuel cells are seen as a promising alternative to traditional power generation technologies due to their low emissions, high efficiency and ease of operation. Fuel cells operate to convert chemical energy to electrical energy. Proton exchange membrane (PEM) fuel cells typically include an anode (oxidizing electrode), a cathode (reducing electrode), and a selective electrolytic membrane disposed between the two electrodes. In a catalyzed reaction, a fuel such as hydrogen, is oxidized at the anode to form cations (protons) and electrons. The ion exchange membrane facilitates the migration of protons from the anode to the cathode. The electrons cannot pass through the membrane, and are forced to flow through an external circuit, thus providing electrical current. At the cathode, oxygen reacts at the catalyst layer, with electrons returned from the electrical circuit, to form anions. The anions formed at the cathode react with the protons that have crossed the membrane to form liquid water as the reaction product. Since the reactions are exothermic, heat is generated within the fuel cell. The half-cell reactions at the two electrodes are as follows:

H₂→2H++2e− (1)

½O₂+2H++2e−H₂O+HEAT (2)

In practice, fuel cells are not operated as single units. Rather, fuel cells are connected in series, stacked one on top of the other, or placed side by side. A series of fuel cells, referred to as fuel cell stack, is normally enclosed in a housing. The fuel and oxidant are directed through manifolds to the electrodes, while cooling is provided either by the reactants or by a separate cooling medium. Also within the stack are current collectors, cell-to-cell seals and insulation. Piping and various instruments are externally connected to the fuel cell stack for supplying and controlling the fluid streams in the system. The stack, housing, and associated hardware make up the fuel cell module.

Various types of fuel cells have been developed employing a broad range of reactants. For example, proton exchange membrane (PEM) fuel cells are one of the most promising replacements for traditional power generation systems. PEM fuel cells comprise an anode, a cathode, and a proton exchange membrane disposed between the two electrodes. Typically, PEM fuel cells are fuelled by pure hydrogen gas, as it is electrochemically reactive and the by-products of the reaction are water and heat. However, these fuel cells require external supply and storage devices for hydrogen. Hydrogen can be difficult to store and handle, particularly in non-stationary applications. Conventional methods of storing hydrogen include liquid hydrogen, compressed gas cylinders, dehydrogenation of compounds, chemical adsorption into metal alloys and chemical storage as hydrides. However, such storage systems tend to be hazardous, dangerous, expensive and/or bulky.

Another method of storing hydrogen using hydride materials, such as that disclosed in U.S. Pat. No. 4,165,569, has turned out to be safer and more practical. This method uses metal hydrides, including, metals, metal alloys to absorb and hold hydrogen gas passing through a hydride bed. After hydrogen is absorbed, the hydride is often sealed in a container to maintain the hydride in the hydrated state. Hydrogen absorbed in the container is usually under pressure (typically about 200 psi). This pressure is much lower than the pressure needed to store compressed hydrogen gas, which requires pressures of 2,500 psi or even pressures as high as 5,000-10,000 psi in high pressure cylinders. When hydrogen is needed, it can be released from the container and supplied to a hydrogen consuming device, such as a fuel cell. The hydrogen absorption process is exothermic while the hydrogen release process is endothermic. This is a reversible reaction of solid metal hydride (Me) with gaseous hydrogen (H2) to form a solid metal hydride (MeHx), which can be described by the following equation:

2/xMe+H₂→MeHₓ+HEAT (3)

Fuel cell systems incorporating metal hydride hydrogen storage means are known in the art. U.S. Pat. No. 5,900,330 discloses a power device employing metal hydride to store hydrogen. The power device includes an electrolysis-fuel cell and a metal hydride hydrogen storage device. The electrolysis-fuel cell receives oxygen from ambient air, hydrogen from the hydrogen storage device, water from an external source and an electric charge from an energy source. During electrolysis operation, the electrolysis-fuel cell electrically disintegrates the water into hydrogen and oxygen. The hydrogen is stored in the hydrogen storage device and the oxygen is purged from said electrolysis-fuel cell as exhaust. During power generation operation, the electrolysis-fuel cell combines hydrogen released from the hydrogen storage device with air in the electrolysis-fuel cell to produce electric power. This power device utilizes the reversible hydrogen absorption reaction shown in equation (3) to store hydrogen.

The system disclosed in U.S. Pat. No. 5,900,330 does not fully utilize heat and water from the fuel cell reaction. It requires frequent refilling of water from an external source to continue its operation, making the system bulky and inefficient, especially for automotive applications.

For fuel cells, especially PEM fuel cells, an important issue to ensure proper performance of the fuel cells is humidification of process gases. Proton exchange membranes require a wet surface to facilitate the conduction of protons from the anode to the cathode, and otherwise to maintain the membranes electrically conductive. It has been suggested that each proton that moves through the membrane drags at least two or three water molecules with it. As the current density increases, the number of water molecules moved through the membrane also increases. Eventually the flux of water being pulled through the membrane by the proton flux exceeds the rate at which water is replenished by diffusion. At this point the membrane begins to dry out, at least on the anode side, and its internal resistance increases. This mechanism drives water to the cathode side. In addition, in operation, excess oxidant is supplied to the cathode side of the fuel cells within a fuel cell stack to react with protons passing through the membrane, forming water as the product on cathode. Unreacted oxidant exits the fuel cell stack from the cathode exhaust port carrying formed water with it. Nonetheless, it is possible for the flow of gas across the cathode side to be sufficient to remove this water, resulting in drying out on the cathode side as well. Accordingly, the surface of the membrane must remain moist at all times. Therefore, to ensure adequate efficiency, the process gases must be humidified to have, on entering the fuel cell, a predetermined or set relative humidity and a predetermined or set temperature which are based on the system requirements. As a result, the cathode exhaust stream of a fuel cell stack has a considerable portion of water, either in gas or liquid phase.

Various methods have been proposed to utilize this water in a fuel cell system, including the employment of heat exchangers and enthalpy wheels.

U.S. Pat. No. 6,277,509 discloses a hydride bed water recovery system for a fuel cell power plant. This water recovery system employs a hydride bed cooler in fluid communication with the process exhaust passage. A manifold is provided for passing the process exhaust stream in heat exchange relationship with the hydride bed. The hydride bed cools the process exhaust stream so that water vapour in the process exhaust stream condenses. A condensed water return line secured between the hydride bed and the fuel cell stack directs water condensed from the process exhaust stream into a coolant loop of the fuel cell power plant. However, this water recovery system is complicated, requiring a large number of components and fails to utilize the hydrogen storage characteristic of the metal hydride materials and heat of the condensed water for increasing the hydrogen production of the hydride bed.

Additionally, to the extent that U.S. Pat. No. 6,277,509 can be understood, it utilizes the hydride bed solely in a closed circuit mode, to effect the water recovery from the process exhaust stream. There is no specific mention of the hydride beds being used as a source of fuel for the fuel cell.

There remains a need for a more compact and efficient fuel cell system that can store hydrogen under relatively low pressure with improved heat and water management. More particularly, such a fuel cell system should have reduced dependence on external water supply.

### SUMMARY OF THE INVENTION

In accordance with a first aspect of the present invention, there is provided a system for supplying hydrogen to a fuel cell, the system comprising:

(a) a hydrogen supply vessel in fluid communication with the fuel cell, the hydrogen supply vessel including a storage medium adapted to store hydrogen gas in a metal hydride and supply hydrogen gas to the fuel cell, wherein the rate of release of the hydrogen gas from the storage medium increases with the temperature of the storage medium;

(b) an exhaust passage connecting the fuel cell and the hydrogen supply vessel, the exhaust passage adapted to receive an exhaust stream from the fuel cell, the system being adapted to pass the exhaust stream in a heat exchange relationship with the storage medium to increase the temperature thereof.

The storage medium is preferably a metal hydride, but other media with suitable properties can be used.

Another aspect of the present invention provides a system for recovering water from a fuel cell, the system comprising:

(a) a hydrogen supply vessel in fluid communication with the fuel cell, the hydrogen supply vessel including a storage medium adapted to store hydrogen gas in a metal hydride and supply hydrogen gas to the fuel cell, wherein the rate of release of the hydrogen gas from the storage medium increases with the temperature of the storage medium;

(b) an exhaust passage connecting the fuel cell and the hydrogen supply vessel, the exhaust passage adapted to receive an exhaust stream from the fuel cell, the system being adapted to pass the exhaust stream in a heat exchange relationship with the storage medium to increase the temperature thereof;

(c) a first liquid gas separator in fluid communication with the exhaust passage, the first liquid gas separator being located downstream of the hydrogen supply vessel, the first liquid gas separator being adapted to separate the water in the liquid phase from exhaust gases of the exhaust stream; and

(d) an electrolyzer in fluid communication with the first liquid gas separator, the electrolyzer being adapted to receive the water from the first liquid gas separator, the electrolyzer being adapted to electrolyze the water to form hydrogen and oxygen, the electrolyzer being adapted to deliver the hydrogen gas to the hydrogen supply vessel for recharge thereof.

The present invention also encompasses a method. Accordingly, a further aspect of the present invention provides a method of supplying hydrogen to a fuel cell, comprising the steps of:

(a) removing an exhaust stream from the fuel cell; and

(b) passing the exhaust stream in heat exchange relationship with a storage medium for storing hydrogen in a metal hydride, thereby increasing the temperature of the storage medium to promote the release of hydrogen ; and

(c) passing the released hydrogen to the fuel cell for consumption by the fuel cell.

A fourth aspect of the present invention provides a method of recovering water from a fuel cell and generating hydrogen for a fuel cell, the method comprising the steps of:

(a) removing an exhaust stream from the fuel cell;

(b) passing the exhaust stream in heat exchange relationship with a storage medium adapted to store hydrogen in a metal hydride, whereby the exhaust stream is cooled to a temperature sufficient to cause the condensation of water in the exhaust stream and heat from the exhaust stream promotes release of hydrogen;

(c) supplying the released hydrogen to the fuel cell, for consumption; and

(d) separating the water from the gases in the exhaust stream and storing the water.

This method can additionally include the steps of:

(e) electrolyzing the stored water to form hydrogen and oxygen; and

(f) supplying the hydrogen formed in step (e) to at least one of the storage medium for recharge thereof and the fuel cell for consumption.

A fifth aspect of the present invention provides a regenerative fuel cell system, comprising:

(a) a fuel cell;

(b) a hydrogen supply vessel in fluid communication with the fuel cell, the hydrogen supply vessel including a storage medium adapted to store hydrogen gas in a metal hydride and supply hydrogen gas to the fuel cell, wherein the rate of release of the hydrogen gas from the storage medium increases with the temperature of the storage medium;

(c) an exhaust passage connecting the fuel cell and the hydrogen supply vessel, the exhaust passage adapted to receive an exhaust stream from the fuel cell, the system being adapted to pass the exhaust stream in a heat exchange relationship with the storage medium to increase the temperature thereof;

(d) a first liquid gas separator in fluid communication with the exhaust passage, the first liquid gas separator being located downstream of the hydrogen supply vessel, the first liquid gas separator being adapted to separate the water in the liquid phase from exhaust gases of the exhaust stream; and

(e) an electrolyzer in fluid communication with the first liquid gas separator, the electrolyzer being adapted to receive the water from the first liquid gas separator, the electrolyzer being adapted to electrolyze the water to form hydrogen and oxygen, the electrolyzer being adapted to deliver the hydrogen gas to the hydrogen supply vessel for recharge thereof.

The metal hydride hydrogen storage and water recovery system according to the present invention provides a safe and compact fuel cell system, eliminating the need for bulky, highly pressurized storage devices and reducing the number of components in the system. Moreover, the present invention utilizes characteristics of the metal hydride and the readily available water in its vicinity, resulting in increased system efficiency. In a regenerative embodiment, the present invention significantly improves the water neutrality thereof by utilizing the reversible characteristic of the metal hydride hydrogen absorption process.

### BRIEF DESCRIPTION OF THE DRAWINGS

For a better understanding of the present invention, and to show more clearly how it may be carried into effect, reference will now be made, by way of example, to the accompanying drawings, which show a preferred embodiment of the present invention and in which:

FIG. 1 is a schematic view of the first embodiment of the hydrogen production and water recovery system for a fuel cell according to the present invention;

FIG. 2 is a schematic view of the second embodiment of the hydrogen production and water recovery system for a fuel cell according to the present invention; and

FIG. 3 is schematic view of the third embodiment of the hydrogen production and water recovery system for a fuel cell according to the present invention.

### DETAILED DESCRIPTION OF THE INVENTION

The features and advantage of the present invention will become more apparent in the light of the following detailed description of preferred embodiments thereof.

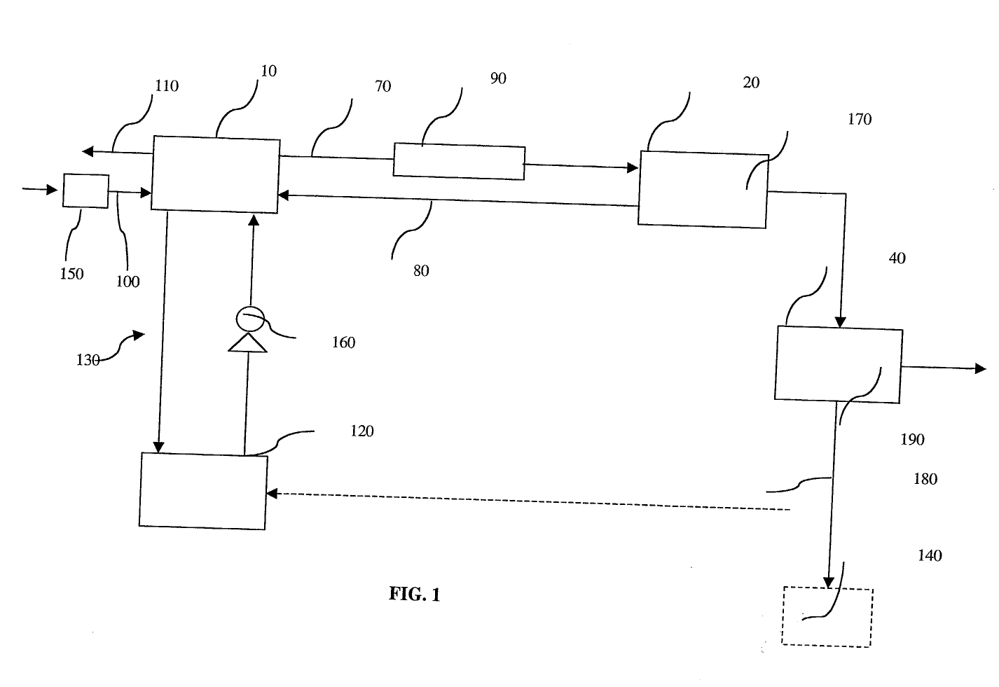

Referring to FIG. 1, a first embodiment of the hydrogen production and water recovery system according to the present invention is shown schematically. The system is connected to one or more fuel cells preferably arranged in a fuel cell stack 10. In a known manner, the fuel cell stack will usually comprise a plurality of fuel cells, but it will be understood that it could comprise just a single fuel cell. For simplicity, reference is made, in the description and claims to a “fuel cell”, and it is to be understood that this encompasses a stack of fuel cells. The water recovery system includes a hydrogen supply vessel, such as a storage tank 20 and a liquid-gas separator 40. The storage tank 20 includes a suitable storage medium, such as a metal alloy capable of storing hydrogen by forming a metal hydride. The alloy forming the metal hydride in the storage tank 20 may be an iron-titanium alloy, mischmetal-nickel alloy, or any other metal alloy that is capable of absorbing hydrogen. An example of a suitable metal hydride is commercially available from Hera. Any storage medium can be used, where hydrogen absorption or storage occurs at a relatively low temperature and hydrogen desorption is caused to occur by heating the storage medium to a relatively high temperature. Hydrogen is stored in the metal hydride storage tank 20 under pressure before the storage tank 20 is coupled to the fuel cell stack 10. A fuel supply passage 80 connects the fuel cell stack 10 and the metal hydride hydrogen storage tank 20 for supplying hydrogen to the anode of the fuel cell stack 10. An oxidant supply passage 100 supplies air preferably from a compressor 150 to the cathode of the fuel cell stack 10. An anode exhaust passage 110 is provided for exhausting excess hydrogen out of the fuel cell stack 10. A cathode exhaust passage 70 connects the fuel cell stack 10 and the metal hydride hydrogen storage tank 20.

In operation, when hydrogen is demanded by the fuel cell stack 10, the hydrogen is released from the metal hydride storage tank 20 and supplied to the anode of the fuel cell stack 10 through the fuel supply passage 80. As is known in the art, the hydrogen reacts on the anode of the fuel cell stack 10 and the unreacted hydrogen leaves the fuel cell stack 10 through the anode outlet thereof and flows out through the anode exhaust passage 110.

An oxidant, such as air, is supplied to the cathode of the fuel cell stack 10 by the compressor 150 and delivered to the fuel cell stack 10 via the oxidant supply passage 100. The oxygen in the air reacts at the cathode of the fuel cell stack 10 and generates water as a product. The cathode exhaust stream leave the fuel cell stack 10 through the cathode outlet (not shown) thereof and flow out through the cathode exhaust passage 70 to the metal hydride storage tank 20. The cathode exhaust stream contains unreacted air and water, including the water generated in fuel cell reaction and the water migrating from the anode side of the fuel cell stack 10.

As the fuel cell reaction is exothermic and the reaction rate is affected by temperature, a coolant loop 130 may be provided for controlling the temperature of the fuel cell stack 10. A coolant, such as deionized water, is continuously circulated between the fuel cell stack 10 and a coolant storage tank 120 by a coolant pump 160, so that the coolant absorbs the heat generated in the fuel cell reaction to maintain the fuel cell stack 10 in an optimized operation temperature range. A heat exchanger (not shown) can be provided in the coolant loop 130 upstream or downstream of the fuel cell stack 10 to maintain the coolant at a desired temperature.

As is known to those skilled in the art, the hydrogen release process in the metal hydride is endothermic. Raising the temperature of the metal hydride will increase the release rate of hydrogen. In conventional systems, as hydrogen is released, the temperature of the metal hydride storage tank 20 decreases, resulting in a reduced release rate of hydrogen. To ensure a stable hydrogen supply in a conventional system, the metal hydride storage tank 20 is heated. On the other hand, fuel cell reaction is exothermic.

In accordance with the present invention, the heat generated in the fuel cell is utilized to control the hydrogen supply from the metal hydride hydrogen storage tank 20.

For this purpose, the cathode exhaust stream is carried by the exhaust passage 70 to the metal hydride hydrogen storage tank 20 in order to bring the exhaust stream into a heat exchange relationship with the metal hydride or other storage medium storage tank 20. This may be accomplished by any suitable means, such as providing a fluid passage or passage or passages (not shown) through the metal hydride or other storage medium of the storage tank 20. This fluid passage is in fluid communication with the cathode exhaust passage 70 so that the cathode exhaust stream from the fuel cell stack 10 can flow through the storage medium along the fluid passage. The water condenses out of the exhaust stream while the heat is transferred to the metal hydride to compensate for the endothermic effect of hydrogen desorption. In this manner, the hydrogen supply to the fuel cell stack 10 can be maintained at a stable level.

The condensed water together with the cooled fuel cell exhaust stream then flows from the metal hydride storage tank 20 along line 170 to the liquid-gas separator 40 in which the water in the liquid phase is separated from the exhaust gas. Since the recovered water is generally pure water, at least a portion of the water may be supplied through a water return line 180 to the coolant storage tank 120 to supplement the possible coolant loss during circulation. Exhaust gas is discharged from the liquid-gas separator 40 to the environment through a discharge line 190.

The recovered water can be utilized for a variety of other purposes. Preferably, the water is provided by a line 180 to a humidifier 140 which may be positioned in either the fuel supply passage 80 or the oxidant supply passage 100 upstream of the fuel cell stack 10. The humidifier 140 may be used to humidify the incoming process gases to prevent drying out of the fuel cell membrane and water loss at the anode. The humidifier 140 may be any device suitable for humidifying gases, including bubbler, packed column humidifiers, membrane humidifiers, enthalpy wheel, or the like.

Alternatively, the coolant storage tank 120 may be a liquid-gas separator. In this case, the condensed water and exhaust stream would flow along line 170 directly to the coolant storage tank 120. The gas-liquid separator 40 may then be omitted.

In practice, the power of the fuel cell stack 10 and the capacity of the metal hydride storage tank 20 can be suitably sized, so that the amount of heat generated by the fuel cell stack 10 is roughly equal to the amount of heat needed by the metal hydride to release hydrogen for consumption by the fuel cell stack 10. Accordingly, a considerable portion of water in the fuel cell exhaust stream can be recovered. Experiments have shown that for a 5 KW fuel cell stack running for 6 hours (30 KWh cycle) with cathode exhaust stream having 90% relative humidity, 11 litres out of the available 15 litres of water was recovered by a metal hydride hydrogen storage tank 20 that stores 20 m³ of hydrogen under STP (standard temperature of 25° C. and pressure of 1 atm). Furthermore, the hydrogen released from the metal hydride is sufficient for consumption by a 7.5 KW fuel cell stack.

Preferably a heat exchanger 90, such as a radiator, is provided in the cathode exhaust passage 70 upstream of the metal hydride hydrogen storage tank 20. This heat exchanger 90 serves to pre-cool the exhaust stream. Experiments have shown that with prior cooling, nearly 100% of the water in fuel cell exhaust stream can be recovered.

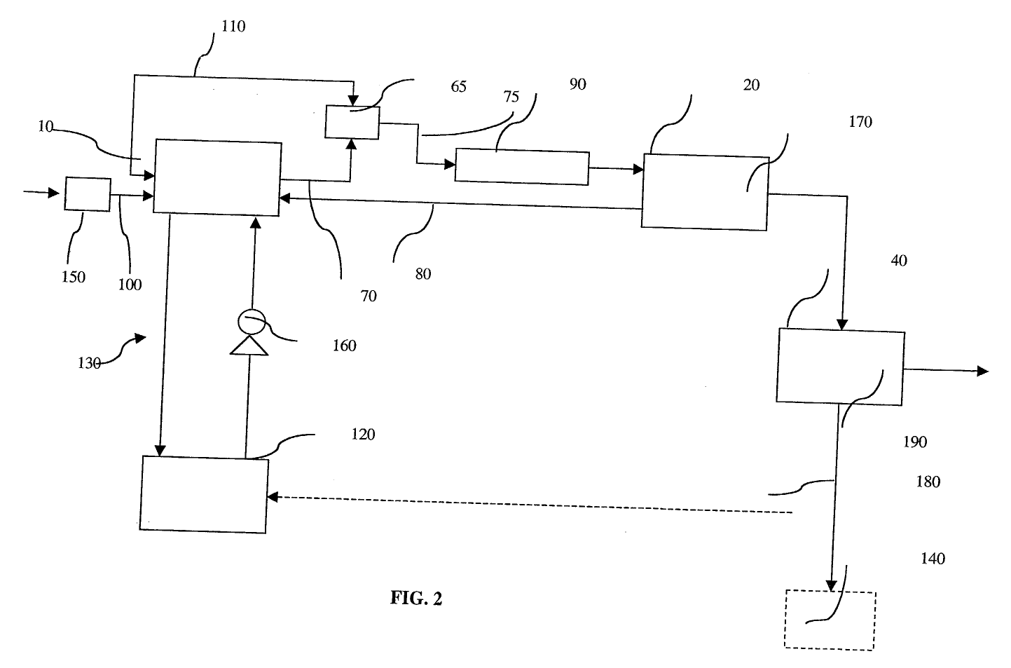

Referring now to FIG. 2, a second embodiment of the present invention is shown. For simplicity, the elements in the system that are identical or similar to those in the first embodiment are indicated with same reference numbers and for brevity, the description of these elements is not repeated. In this embodiment, a catalytic burner 65 is added to the system shown in FIG. 1.

The excess, unreacted hydrogen leaving the fuel cell stack 10 along the anode exhaust passage 110 and the excess, unreacted oxygen in the air leaving the fuel cell stack 10 along the cathode exhaust passage 70, are both directed to the catalytic burner 65. In the catalytic burner 65, the hydrogen and the oxygen react in the presence of an appropriate catalyst to form water as follows:

2H₂+O₂→2H₂O (4)

Then, the mixture of water and unreacted exhaust of the fuel cell stack 10, as process exhaust, flows from the catalytic burner 65 to the metal hydride hydrogen storage tank 20 along a process exhaust passage 75. As described in detail for the first embodiment above, the process exhaust stream in the process exhaust passage 75 is brought into heat exchange relationship with the storage medium in the metal hydride hydrogen storage tank 20. The water condenses out of the process exhaust stream while the heat is transferred to the metal hydride or other storage medium to compensate the endothermic effect of hydrogen desorption. Again, a heat exchanger 90 may be provided in the process exhaust passage 75 upstream of the metal hydride hydrogen storage tank 20 to pre-cool the process exhaust stream and enhance the overall water recovery efficiency.

In this embodiment, the excess reactants are utilized to form water. The exhaust of the fuel cell system is reduced and more water can be recovered. In this embodiment, the water in the process exhaust passage 75 consists of water from the both the anode and cathode exhaust streams, as well as water results from the reaction of excess reactants. Accordingly, this embodiment enhances the water recovery capability of the system.

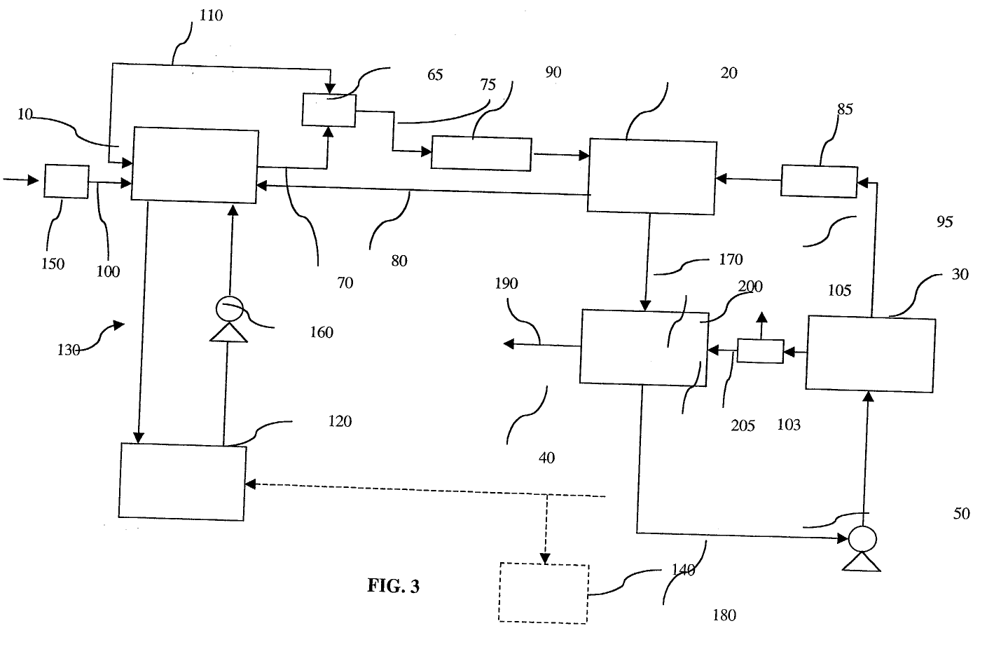

Referring now to FIG. 3, a third embodiment of the present invention is shown. Again, for simplicity, the elements in the system that are identical or similar to those in the first and second embodiments are indicated with same reference numbers and for brevity, the description of these elements is not repeated.

In this embodiment, a regenerative fuel cell system is shown. The regenerative fuel cell system includes a fuel cell stack 10, an electrolyzer 30, a metal hydride hydrogen storage tank 20, a coolant storage tank 120 and a first liquid-gas separator 40.

As described in detail for the second embodiment shown in FIG. 2, the mixture of water and exhaust gases, as process exhaust, flows along the process exhaust passage 75 into heat exchange relationship with the metal hydride or other storage medium storage tank 20. Water is then condensed out of the mixture while heat is transferred to the metal hydride contained in the storage tank 20. The process exhaust stream is then directed to the first liquid-gas separator 40 in which substantially pure liquid water is separated from the gas. The separated gas is then exhausted to the environment through the discharge line 190. The recovered water is then directed to the electrolyzer 30 through the water return line 180 by means of a return pump 50. In the electrolyzer 30, water is electrolyzed according to the following equations:

Anode: H₂O→½O₂+2H++2e− (5)

Cathode: 2H++2e−→H₂ (6)

The product of the electrolysis reaction is hydrogen and oxygen. The generated hydrogen is then directed to the metal hydride hydrogen storage tank 20 from the cathode of the electrolyzer 30 along a hydrogen recharge line 95. The generated oxygen along with unreacted water from the anode of the electrolyzer 30 may be directed to a second liquid-gas separator 205 along line 103. The second liquid-gas separator 205 separates the generated oxygen from the unreacted water. The oxygen may then be directed along line 105 to an oxygen storage device (not shown) or discharged to the environment. In the event that the fuel cell stack 10 employs pure oxygen as oxidant, the generated oxygen in line 105 may be directly supplied to the cathode of the fuel cell stack 10 for reaction. The unreacted water is returned to the first liquid gas separator 40 along line 200.

Alternatively, if the generated oxygen was not used, the unreacted water and generated oxygen would be directed directly from the anode of the electrolyzer 30 to the first liquid-gas separator 40, where the oxygen would be vented along line 190.

Preferably, a heat exchanger 85 is provided in the hydrogen recharge line 95 upstream of the metal hydride hydrogen storage tank 20 to lower the temperature of the generated hydrogen. As mentioned, the hydrogen absorption process is exothermic. Lowering the temperature facilitate the hydrogen absorption. More preferably, a compressor (not shown) is provided to supply pressurized hydrogen to the storage tank 20 to further enhance the absorption.

Although a catalytic burner 65 is provided in this embodiment to utilize the excess reactants, it is not essential. It will also be understood by those skilled in the art that either the anode or cathode exhaust stream alone may be provided directly to the metal hydride hydrogen storage tank 20, as described in FIG. 1 above.

Optionally, a portion of the recovered water can be directed to the coolant storage tank 120 or to a humidifier 140, as indicated by the dotted line in FIG. 3. The humidifier 140, or humidifiers can be positioned in either fuel supply passage 80 or oxidant supply line 100 or both. Again, the heat exchanger 90 in the process exhaust line 75 is optional.

Optionally, in all three embodiments, another heat exchanger (not shown) may be provided in line 170 between the metal hydride storage tank 20 and the liquid-gas separator 40 to further cool the mixture of exhaust and water, thereby improving the effect of water recovery.

In the third embodiment, the present invention significantly improves the water neutrality which is a critical factor of regenerative fuel cell systems. This is especially advantageous in remote applications, where refilling the regenerative system with water is difficult. Experiments have shown that without water recovery from the fuel cell stack 10, each 30 KWh cycle needs a refill of about 15 liters of water for the electrolyzer 30 to recharge the metal hydride storage tank 20 with same amount of hydrogen (20 m³ STP) consumed by the fuel cell stack 10. The present invention reduces this amount by at least 11 liters.

The operation of the regenerative system according to the embodiment illustrated in FIG. 3 preferably alternates between two modes. The system operates in a fuel cell mode to produce power. In this mode, the water recovered from the exhaust stream as described above is stored in the first liquid gas separator 40. When hydrogen regeneration is required, the system operates in a regenerative mode. In this mode, the water from the first liquid gas separator 40 is provided to the electrolyzer 30 to produce hydrogen as described in detail above. Preferably, the electrolyzer 30 is connected to its own power supply (not shown) when the system is operating in the regenerative mode.

However, it will be understood by those skilled in the art that the fuel cell stack 10 and the electrolyzer 30 may be operated contemporaneously. In such an embodiment, the electrolyzer 30 may be powered by electricity produced by the fuel cell stack 10, although the power produced by the system will be reduced.

The present invention has been described in detail by way of a number of embodiments. It is anticipated that those having ordinary skills in the art can make various modifications to the embodiments disclosed herein after learning the teaching of the present invention. The number and arrangement of components in the system might be different, different elements might be used to achieve the same specific function. The present invention might have applicability in other types of fuel cells that employ pure hydrogen as a fuel, which include but are not limited to, solid oxide, alkaline, molton-carbonate, and phosphoric acid. Similarly, the electrolyzer can be any type of electrolyzer. However, these modifications should be considered to fall under the protection scope of the invention as defined in the following claims.

1. A system for supplying hydrogen to a fuel cell, the system comprising:
a) a hydrogen supply vessel in fluid communication with the fuel cell, the hydrogen supply vessel including a storage medium adapted to store hydrogen gas in a metal hydride and supply hydrogen gas to the fuel cell, wherein the rate of release of the hydrogen gas from the storage medium increases with the temperature of the storage medium;
b) an exhaust passage connecting the fuel cell and the hydrogen supply vessel, the exhaust passage adapted to receive an exhaust stream from the fuel cell, the system being adapted to pass the exhaust stream in a heat exchange relationship with the storage medium to increase the temperature thereof.

2. The system of claim 1, further comprising a means for passing the exhaust stream in heat exchange relationship with the storage medium to condense the water in the exhaust stream.

3. The system of claim 2, further comprising a first liquid gas separator in fluid communication with the exhaust passage, the first liquid gas separator being located downstream of the hydrogen supply vessel, the first liquid gas separator being adapted to separate the water in the liquid phase from exhaust gases of the exhaust stream.

4. The system of claim 3, wherein the first liquid gas separator discharges the exhaust gases into the environment.

5. The system of claim 3, further comprising a humidifier in fluid communication with the liquid gas separator, the humidifier being adapted to receive the water from the liquid gas separator and to humidify at least one of the hydrogen gas supplied to the fuel cell and an oxidant gas supplied to the fuel cell.

6. The system of claim 3, further comprising a first heat exchanger in fluid communication with the exhaust passage, the heat exchanger being located upstream of the hydrogen supply vessel, the heat exchanger being adapted to cool the exhaust stream.

7. The system of claim 6, further comprising a second heat exchanger located between the hydrogen supply vessel and the first liquid gas separator, the second heat exchanger being adapted to cool the exhaust stream.

8. The system of claim 3, further comprising a catalytic burner in fluid communication with the fuel cell, the catalytic burner being adapted to receive an anode exhaust and a cathode exhaust from the fuel cell, the catalytic burner being adapted to react at least a portion of the excess oxygen from the cathode exhaust with at least a portion of the hydrogen from the anode exhaust to form water, the catalytic burner being connected to the exhaust passage upstream of the hydrogen supply vessel to deliver water and any residual gases thereto.

9. The system of claim 3, further comprising an electrolyzer in fluid communication with the first liquid gas separator, the electrolyzer being adapted to receive the water from the first liquid gas separator, the electrolyzer being adapted to electrolyze the water to form hydrogen and oxygen, the electrolyzer being adapted to deliver the hydrogen gas to the hydrogen supply vessel for recharge thereof

10. The system of claim 9, further comprising a third heat exchanger adapted to lower the temperature of the hydrogen gas provided by the electrolyzer to the hydrogen supply vessel.

11. The system of claim 10, further comprising a return pump in fluid communication with the first liquid gas separator and the electrolyzer, the return pump being adapted to deliver the water from the first liquid gas separator to the electrolyzer.

12. The system of claim 9, further comprising a second liquid gas separator located downstream of the electrolyzer, the second liquid gas separator being adapted to receive the oxygen and unreacted water from the electrolyzer for separation thereof, the second liquid gas separator being adapted to return the unreacted water to the first liquid gas separator.

13. The system of claim 12, wherein the second liquid gas separator is adapted to deliver the oxygen to an oxygen storage device.

14. The system of claim 9, wherein the oxygen is delivered to an cathode of the fuel cell.

15. The system of claim 3, further comprising a coolant loop adapted to cool the fuel cell.

16. The system of claim 15, wherein the first liquid gas separator is adapted to deliver at least a portion of the water to the coolant loop.

17. The system of claim 9, wherein the coolant loop comprises a coolant storage tank, a coolant pump, and a coolant passage adapted to bring the coolant storage tank and the pump into fluid communication, the pump being adapted to circulate coolant fluid through the coolant loop, the coolant passage adapted to bring the coolant fluid into heat exchange relationship with the fuel cell to reduce the temperature thereof.

18. A system for recovering water from a fuel cell, the system comprising:
a) a hydrogen supply vessel in fluid communication with the fuel cell, the hydrogen supply vessel including a storage medium adapted to store hydrogen gas in a metal hydride and supply hydrogen gas to the fuel cell, wherein the rate of release of the hydrogen gas from the storage medium increases with the temperature of the storage medium;
b) an exhaust passage connecting the fuel cell and the hydrogen supply vessel, the exhaust passage adapted to receive an exhaust stream from the fuel cell, the system being adapted to pass the exhaust stream in a heat exchange relationship with the storage medium to increase the temperature thereof;
c) a first liquid gas separator in fluid communication with the exhaust passage, the first liquid gas separator being located downstream of the hydrogen supply vessel, the first liquid gas separator being adapted to separate the water in the liquid phase from exhaust gases of the exhaust stream; and
d) an electrolyzer in fluid communication with the first liquid gas separator, the electrolyzer being adapted to receive the water from the first liquid gas separator, the electrolyzer being adapted to electrolyze the water to form hydrogen and oxygen, the electrolyzer being adapted to deliver the hydrogen gas to the hydrogen supply vessel for recharge thereof.

19. The system of claim 18, further comprising a means for passing the exhaust stream in heat exchange relationship with the storage medium to condense the water in the exhaust stream.

20. The system of claim 18, wherein the electrolyzer is adapted to return the unreacted water to the first liquid gas separator.

21. The system of claim 18, further comprising a first heat exchanger in fluid communication with the exhaust passage, the heat exchanger being located upstream of the hydrogen supply vessel, the heat exchanger being adapted to cool the exhaust stream.

22. The system of claim 18, further comprising a second heat exchanger located between the hydrogen supply vessel and the first liquid gas separator, the second heat exchanger being adapted to cool the exhaust stream.

23. The system of claim 18, further comprising a third heat exchanger adapted to lower the temperature of the hydrogen gas provided by the electrolyzer to the hydrogen supply vessel.

24. The system of claim 18, further comprising a return pump in fluid communication with the first liquid gas separator and the electrolyzer, the return pump being adapted to deliver the water from the first liquid gas separator to the electrolyzer.

25. The system of claim 18, further comprising a second liquid gas separator located downstream of the electrolyzer, the second liquid gas separator being adapted to receive the oxygen and unreacted water from the electrolyzer for separation thereof, the second liquid gas separator being adapted to return the unreacted water to the first liquid gas separator.

26. The system of claim 25, wherein the second liquid gas separator is adapted to deliver the oxygen to an oxygen storage device.

27. The system of claim 18, further comprising a catalytic burner in fluid communication with the fuel cell, the catalytic burner being adapted to receive an anode exhaust and a cathode exhaust from the fuel cell, the catalytic burner being adapted to react at least a portion of the excess oxygen from the cathode exhaust with at least a portion of the hydrogen from the anode exhaust to form water, the catalytic burner being connected to the exhaust passage upstream of the hydrogen supply vessel to deliver water and any residual gases thereto.

28. The system of claim 18, wherein the first liquid gas separator is adapted to deliver at least a portion of the water to a coolant loop adapted to cool the fuel cell.

29. The system of claim 28, wherein the coolant loop comprises a coolant storage tank, a coolant pump, and a coolant passage adapted to bring the coolant storage tank and the pump into fluid communication, the pump being adapted to circulate coolant fluid through the coolant loop, the coolant passage adapted to bring the coolant fluid into heat exchange relationship with the fuel cell to reduce the temperature thereof.

30. A method of supplying hydrogen to a fuel cell, comprising the steps of:
a) removing an exhaust stream from the fuel cell; and
b) passing the exhaust stream in heat exchange relationship with a storage medium for storing hydrogen in a metal hydride, thereby increasing the temperature of the storage medium to promote the release of hydrogen; and
c) passing the released hydrogen to the fuel cell for consumption by the fuel cell.

31. The method of claim 30, which includes cooling the exhaust stream by heat exchange with the storage medium to a temperature sufficiently low to cause condensation.

32. The method of claim 31 further comprising the step of separating the water from the gases in the exhaust stream.

33. The method of claim 32, further comprising returning at least a portion of the water to a coolant loop.

34. The method of claim 32, further comprising using at least a portion of the water to humidify an anode supply stream.

35. The method of claim 32, further comprising using at least a portion of the water to humidify a cathode supply stream.

36. The method of claim 32 further comprising the step of electrolyzing the water to form hydrogen and oxygen.

37. The method of claim 36, further comprising the step of returning the oxygen to a fuel cell cathode.

38. The method of claim 36 further comprising returning the hydrogen to the storage medium for recharge thereof.

39. The method of claim 37, wherein prior to returning the hydrogen to the hydrogen supply vessel, the hydrogen is cooled.

40. The method of claim 39, wherein prior to returning the hydrogen to the hydrogen supply vessel, the hydrogen is pressurized.

41. The method of claim 30, wherein the exhaust stream comprises a cathode exhaust stream.

42. The method of claim 30, wherein prior to step (b), the method further comprises reacting the hydrogen in an anode exhaust portion of the exhaust stream with the oxygen in a cathode exhaust portion of the exhaust stream to form water.

43. The method of claim 30, wherein prior to step (b), the method further comprises the step of pre-cooling the exhaust stream.

44. The method of claim 32, wherein after step (b) and prior to separating the water from the gases in the exhaust stream, the method further comprises cooling the exhaust stream.

45. A method of recovering water from a fuel cell and generating hydrogen for a fuel cell, the method comprising, the steps of:
a) removing an exhaust stream from the fuel cell;
b) passing the exhaust stream in heat exchange relationship with a storage medium adapted to store hydrogen in a metal hydride, whereby the exhaust stream is cooled to a temperature sufficient to cause the condensation of water in the exhaust stream and heat from the exhaust stream promotes release of hydrogen;
c) supplying the released hydrogen to the fuel cell, for consumption; and
d) separating the water from the gases in the exhaust stream and storing the water.

46. The method as claimed in claim 45, the method additionally including:
e) electrolyzing the stored water to form hydrogen and oxygen; and
f) supplying the hydrogen formed in step (e) to at least one of the storage medium for recharge thereof and the fuel cell for consumption.

47. The method as claimed in claim 46, which includes, at some times, effecting steps (a), (b), (c) and (d) without steps (e) and (f), and at other times, effecting steps (e) and (f) without steps (a), (b), (c) or (d).

48. The method of claim 46, wherein step (b) includes increasing the temperature of the storage medium to promote release of hydrogen.

49. The method of claim 48, wherein the hydrogen generated in step (f) is supplied to the fuel cell.

50. The method of claim 46, further comprising the step of returning the oxygen to a fuel cell cathode.

51. The method of claim 46, wherein prior to returning the hydrogen to the hydrogen supply vessel, the hydrogen is cooled.

52. The method of claim 51, wherein prior to returning the hydrogen to the storage medium, the hydrogen is pressurized.

53. The method of claim 46, wherein prior to step (b), the method further comprises reacting the hydrogen in an anode exhaust portion of the exhaust stream with the oxygen in a cathode exhaust portion of the exhaust stream to form water.

54. The method of claim 46, wherein prior to step (b), the method further comprises the step of pre-cooling the exhaust stream.

55. The method of claim 46, wherein after step (b) and prior to step (c), the method further comprises cooling the exhaust stream.

56. The method of claim 46, further comprising returning at least a portion of the water to a coolant loop.

57. The method of claim 46, further comprising using at least a portion of the water to humidify an anode supply stream.

58. The method of claim 46, further comprising using at least a portion of the water to humidify a cathode supply stream.

59. A regenerative fuel cell system, comprising:
a) a fuel cell,
b) a hydrogen supply vessel in fluid communication with the fuel cell, the hydrogen supply vessel including a storage medium adapted to store hydrogen gas in a metal hydride and supply hydrogen gas to the fuel cell, wherein the rate of release of the hydrogen gas from the storage medium increases with the temperature of the storage medium;
c) an exhaust passage connecting the fuel cell and the hydrogen supply vessel, the exhaust passage adapted to receive an exhaust stream from the fuel cell, the system being adapted to pass the exhaust stream in a heat exchange relationship with the storage medium to increase the temperature thereof;
d) a first liquid gas separator in fluid communication with the exhaust passage, the first liquid gas separator being located downstream of the hydrogen supply vessel, the first liquid gas separator being adapted to separate the water in the liquid phase from exhaust gases of the exhaust stream; and
e) an electrolyzer in fluid communication with the first liquid gas separator, the electrolyzer being adapted to receive the water from the first liquid gas separator, the electrolyzer being adapted to electrolyze the water to form hydrogen and oxygen, the electrolyzer being adapted to deliver the hydrogen gas to the hydrogen supply vessel for recharge thereof.
